(19) United States
(12) Patent Application Publication
(10) Pub. No.: US 2012/0147718 A1
(43) Pub. Date: Jun. 14, 2012

(54) PATTERNED PERPENDICULAR MAGNETIC RECORDING MEDIUM WITH EXCHANGE-COUPLED COMPOSITE RECORDING STRUCTURE OF A FePt LAYER AND A Co/X MULTILAYER

(76) Inventors: Olav Hellwig, San Jose, CA (US); Andrew Thomas McCallum, San Jose, CA (US); Dieter K. Weller, San Jose, CA (US)

(21) Appl. No.: 12/964,643

(22) Filed: Dec. 9, 2010

(51) Int. Cl. G11B 5/667; G11B 11/00; G11B 5/127; G11B 5/66; G11B 5/65

(52) U.S. Cl. 369/13.33; 428/833.1; 428/832; 428/831; 428/827; 360/110; G9B/5.241; G9B/5.04; G9B/11

(57) ABSTRACT

A bit-patterned media (BPM) magnetic recording disk has discrete data islands with an exchange-coupled composite (ECC) recording layer (RL) formed of a high-anisotropy chemically-ordered FePt alloy lower layer, a lower-anisotropy Co/X laminate or multilayer (ML) upper layer with perpendicular magnetic anisotropy, wherein X is Pt, Pd or Ni, and an optional nonmagnetic separation layer or coupling layer (CL) between the FePt layer and the ML. The FePt alloy layer is sputter deposited onto a seed layer structure, like a CrRu/Pt bilayer, while the disk substrate is maintained at an elevated temperature to assure the high anisotropy field Hₖ is achieved. The high-temperature deposition together with the CrRu/Pt seed layer structure provide a very smooth surface for subsequent deposition of the ML (and optional CL). The separate Co/X ML has by itself a very narrow switching field distribution (SFD), so that the SFD of the ECC RL is much narrower than the SFD for the FePt layer alone.

### BACKGROUND OF THE INVENTION

1. Field of the Invention

This invention relates generally to patterned perpendicular magnetic recording media, such as disks for use in magnetic recording hard disk drives, and more particularly to patterned disks with data islands having improved magnetic recording properties.

2. Description of the Related Art

Magnetic recording hard disk drives with patterned magnetic recording media have been proposed to increase data density. In conventional continuous magnetic recording media, the magnetic recording layer is a continuous layer over the entire surface of the disk. In patterned media, also called bit-patterned media (BPM), the magnetic recording layer on the disk is patterned into small isolated data islands arranged in concentric data tracks. While BPM disks may be longitudinal magnetic recording disks, wherein the magnetization directions are parallel to or in the plane of the recording layer, perpendicular magnetic recording disks, wherein the magnetization directions are perpendicular to or out-of-the-plane of the recording layer, will likely be the choice for BPM because of the increased data density potential of perpendicular media. To produce the magnetic isolation of the patterned data islands, the magnetic moment of the spaces between the islands are destroyed or substantially reduced to render these spaces essentially nonmagnetic. Alternatively, the media may be fabricated so that there is no magnetic material in the spaces between the islands.

Nanoimprint lithography (NIL) has been proposed to form the desired pattern of islands on BPM disks. NIL is based on deforming an imprint resist layer by a master template or mold having the desired nano-scale pattern. The master template is made by a high-resolution lithography tool, such as an electron-beam tool. The substrate to be patterned may be a disk blank formed of an etchable material, like quartz, glass or silicon, or a disk blank with the magnetic recording layer, and any required underlayers, formed on it as continuous layers. Then the substrate is spin-coated with the imprint resist, such as a thermoplastic polymer, like poly-methylmethacrylate (PMMA). The polymer is then heated above its glass transition temperature. At that temperature, the thermoplastic resist becomes viscous and the nano-scale pattern is reproduced on the imprint resist by imprinting from the template at a relatively high pressure. Once the polymer is cooled, the template is removed from the imprint resist leaving an inverse nano-scale pattern of recesses and spaces on the imprint resist. As an alternative to thermal curing of a thermoplastic polymer, a polymer curable by ultraviolet (UV) light, such as MonoMat available from Molecular Imprints, Inc., can be used as the imprint resist. The patterned imprint resist layer is then used as an etch mask to form the desired pattern of islands in the underlying substrate.

The islands in BPM need to be sufficiently small and of sufficient magnetic quality to support high bit areal densities (e.g., 500 Gb/in² and beyond). For example, to achieve a bit areal density of 1 Tb/in², the data islands will have diameters approximately 15 to 20 nm with the nonmagnetic spaces between the islands having widths of about 10 to 15 nm. It is thus important that as the size of the islands decreases, the thermal stability of the islands is maintained.

Another critical issue for the development of BPM is that the switching field distribution (SFD) (i.e., the island-to-island variation of the coercive field) needs to be narrow enough to insure exact addressability of individual islands without overwriting adjacent islands. Ideally the SFD width would be zero, meaning that all the bits would switch at the same write field strength. The SFD has many origins, such as variations in the size, shape and spacing of the patterned islands, the intrinsic magnetic anisotropy distribution of the magnetic material used, and dipolar interactions between adjacent islands. Additionally, it has been found that the SFD broadens (that is, the bit-to-bit variation in the coercive field increases) as the size of the magnetic islands is reduced, which limits the achievable bit areal density of BPM.

Exchange-spring media, also called exchange-coupled composite (ECC) media, are known for perpendicular magnetic recording. An ECC perpendicular recording material is a composite of two or more ferromagnetically exchange-coupled magnetic layers with substantially different anisotropy fields (Hₖ). (The effective anisotropy field Hₖ of a ferromagnetic layer with uniaxial magnetic anisotropy Kᵤ is essentially the magnetic field that needs to be applied along the hard axis to align the magnetization completely into the external field direction.) Magnetic simulation of this composite medium shows that in the presence of a uniform write field the magnetization of the lower-Hₖ layer will rotate first and assist in the reversal of the magnetization of the higher-Hₖ layer. This behavior is sometimes called the “exchange-spring” behavior. Various types of ECC media are described by R. H. Victora et al., “Composite Media for Perpendicular Magnetic Recording”, IEEE Trans MAG 41 (2), 537-542, February 2005; and J. P. Wang et al., “Composite media (dynamic tilted media) for magnetic recording”, Appl. Phys. Lett. 86 (14) Art. No. 142504, Apr. 4, 2005. Pending application Ser. Nos. 11/751,823 and 12/412,403, both assigned to the same assignee as this application, describe various types of perpendicular BPM with data islands formed of ECC material.

What is needed is a patterned perpendicular magnetic recording medium that has islands of ECC material with high thermal stability and a narrow SFD.

### SUMMARY OF THE INVENTION

This invention relates to bit-patterned media (BPM) wherein the recording layer (RL) in the discrete magnetic islands is an exchange-coupled composite (ECC) structure with a high-Hₖ chemically-ordered FePt alloy lower layer, a lower-Hₖ Co/X laminate or multilayer (ML) upper layer with perpendicular magnetic anisotropy, wherein X is Pt, Pd or Ni, and an optional nonmagnetic separation layer or coupling layer (CL) between the FePt layer and the ML. The hard (high_Hₖ) FePt layer is preferably the chemically-ordered equiatomic binary alloy FePt based on the L1₀ phase, but may also be a pseudo-binary alloy based on the FePt L1₀ phase, e.g., (Fe(y)Pt(100−y))-X, where y is between about 45 and 55 atomic percent and the element X may be Ni, Au, Cu, Pd or Ag and is present in the range of between about 0% to about 20% atomic percent. The FePt alloy layer is sputter deposited onto a seed layer structure, like a CrRu/Pt bilayer, while the disk substrate is maintained at an elevated temperature to assure the high anisotropy field Hₖ is achieved. The high-temperature deposition, together with the CrRu/Pt seed layer structure, provides a very smooth surface for subsequent deposition of the ML (and optional CL). The ML is formed on the FePt layer (or on the optional CL) and comprises a series of Co/X bilayers, wherein X is Pt, Pd or Ni. The number of bilayers and the relative thicknesses of the Co and X layers are selected to achieve the desired magnetic properties, including the value of the anisotropy field Hₖ. The separate Co/X ML has by itself a very narrow switching field distribution (SFD), more narrow than the SFD for the FePt layer, so that the SFD of the composite RL has a narrow SFD. The ECC RL provides a strong readback signal due to the well defined perpendicular anisotropy of both the hard (high-Hₖ) FePt layer and the soft (lower-Hₖ) Co/X ML.

The ECC RL is used in the discrete data islands of perpendicular BPM disks that may have a soft magnetic underlayer (SUL) below the data islands to act as a flux return path for the magnetic write field, and an exchange break layer (EBL) between the SUL and the data islands to break the magnetic exchange coupling between the RL and the SUL. The ECC RL may also be used in the discrete data islands of perpendicular BPM disks in thermally-assisted recording (TAR) disk drives. In a TAR disk drive, a heat sink layer may be located below the data islands.

For a fuller understanding of the nature and advantages of the present invention, reference should be made to the following detailed description taken together with the accompanying figures.

### BRIEF DESCRIPTION OF THE DRAWING

FIG. 1 is a top view of a perpendicular magnetic recording disk drive with bit-patterned media (BPM) and shows the patterned data islands arranged in concentric circular data tracks according to the prior art.

FIG. 2 is a top view of an enlarged portion of a prior art BPM disk showing the detailed arrangement of the data islands.

FIGS. 3A-3C are sectional views of a BPM disk at various stages of etching and planarizing the disk according to the prior art.

FIG. 4 is a sectional view of a portion of a disk substrate showing a data island with the exchange-coupled composite (ECC) recording layer (RL) according to the invention.

FIG. 5A shows the comparison of anisotropy field distribution for a high-Hₖ FePt L1₀ layer with a lower-Hₖ FePt L1₀ layer.

FIG. 5B shows the comparison of anisotropy field distribution for a high-Hₖ FePt L1₀ layer with a lower-Hₖ Co/Pd or Co/Ni multilayer deposited at room temperature.

FIG. 6 is a sectional view of an air-bearing slider for use in a thermally-assisted recording (TAR) system and a portion of a TAR disk with data islands having the ECC RL according to the invention.

### DETAILED DESCRIPTION OF THE INVENTION

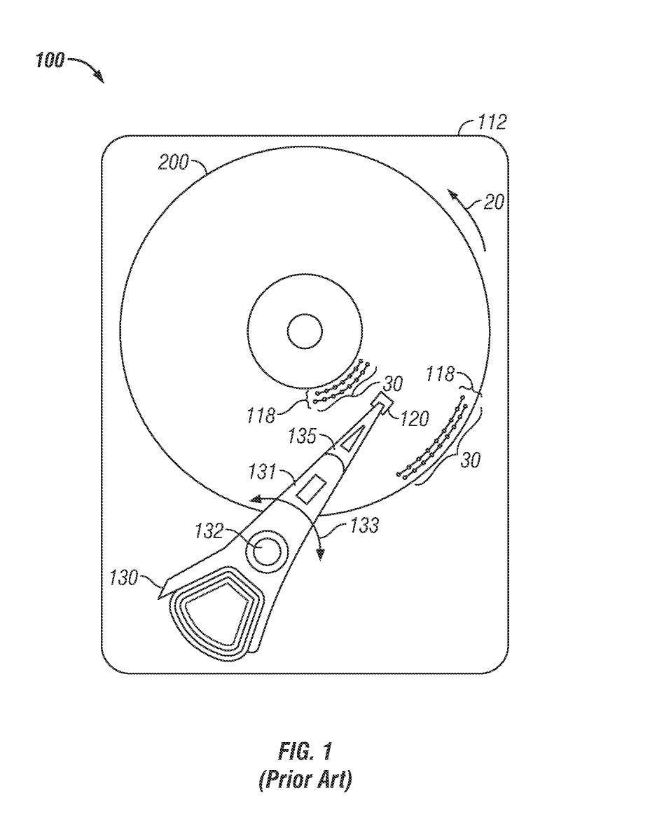

FIG. 1 is a top view of a patterned-media magnetic recording disk drive 100 with a patterned-media magnetic recording disk 200. The drive 100 has a housing or base 112 that supports an actuator 130 and a drive motor for rotating the magnetic recording disk 200. The actuator 130 may be a voice coil motor (VCM) rotary actuator that has a rigid arm 131 and rotates about pivot 132 as shown by arrow 133. A head-suspension assembly includes a suspension 135 that has one end attached to the end of actuator arm 131 and a head carrier, such as an air-bearing slider 120, attached to the other end of suspension 135. The suspension 135 permits the slider 120 to be maintained very close to the surface of disk 200 and enables it to “pitch” and “roll” on the air-bearing generated by the disk 200 as it rotates in the direction of arrow 20. A magnetoresistive read head (not shown) and an inductive write head (not shown) are typically formed as an integrated read/write head patterned as a series of thin films and structures on the trailing end of the slider 120, as is well known in the art. The slider 120 is typically formed of a composite material, such as a composite of alumina/titanium-carbide (Al₂O₃/TiC). Only one disk surface with associated slider and read/write head is shown in FIG. 1, but there are typically multiple disks stacked on a hub that is rotated by a spindle motor, with a separate slider and read/write head associated with each surface of each disk.

The patterned-media magnetic recording disk 200 includes a hard or rigid disk substrate and discrete data islands 30 of magnetizable material on the substrate. The data islands 30 are arranged in radially-spaced circular tracks 118, with only a few islands 30 and representative tracks 118 near the inner and outer diameters of disk 200 being shown in FIG. 1. The islands 30 are depicted as having a circular shape but the islands may have other shapes, for example generally rectangular, oval or elliptical. As the disk 200 rotates in the direction of arrow 20, the movement of actuator 130 allows the read/write head on the trailing end of slider 120 to access different data tracks 118 on disk 200.

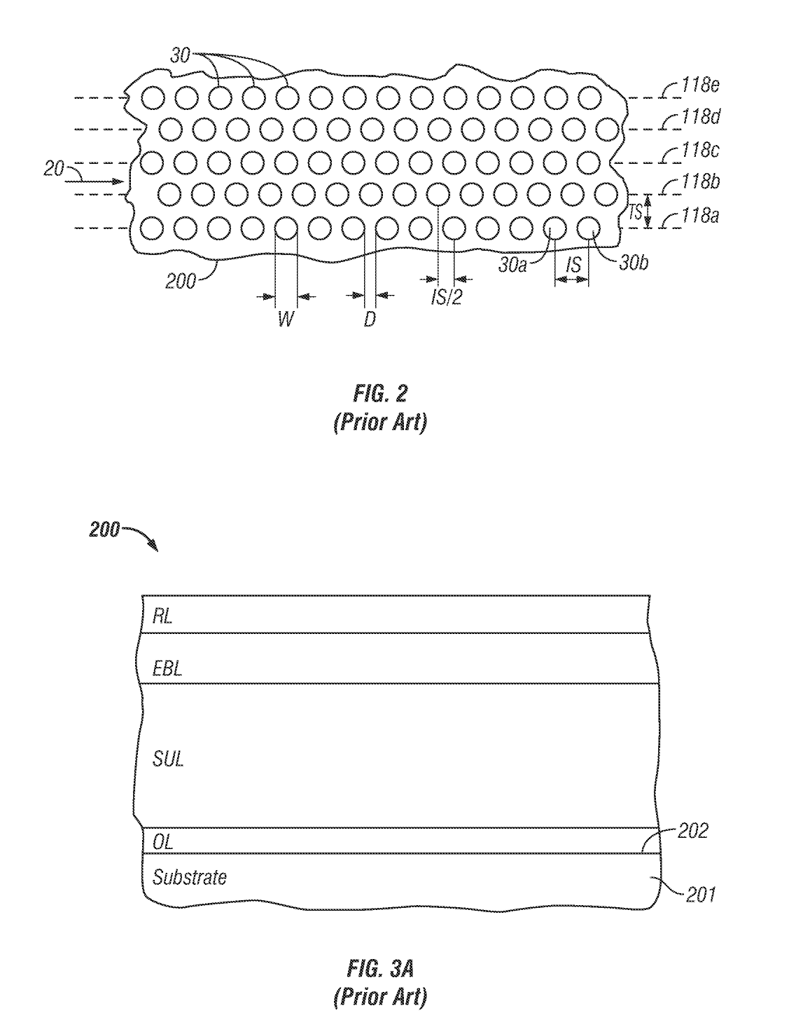

FIG. 2 is a top view of an enlarged portion of disk 200 showing the detailed arrangement of the data islands 30 on the surface of the disk substrate in one type of pattern according to the prior art. The islands 30 contain magnetizable recording material and are arranged in circular tracks spaced-apart in the radial or cross-track direction, as shown by tracks 118a-118e. The tracks are typically equally spaced apart by a fixed track spacing TS. The spacing between data islands in a track is shown by distance IS between data islands 30a and 30b in track 118a, with adjacent tracks being shifted from one another by a distance IS/2, as shown by tracks 118a and 118b. Each island has a lateral dimension W parallel to the plane of the disk 200, with W being the diameter if the islands have a circular shape. The islands may have other shapes, for example generally rectangular, oval or elliptical, in which case the dimension W may be considered to be the smallest dimension of the non-circular island, such as the smaller side of a rectangular island. The adjacent islands are separated by nonmagnetic regions or spaces, with the spaces having a lateral dimension D. The value of D may be greater than the value of W.

BPM disks like that shown in FIG. 2 may be perpendicular magnetic recording disks, wherein the magnetization directions are perpendicular to or out-of-the-plane of the recording layer in the islands. To produce the required magnetic isolation of the patterned data islands 30, the magnetic moment of the regions or spaces between the islands 30 must be destroyed or substantially reduced to render these spaces essentially nonmagnetic. The term “nonmagnetic” means that the spaces between the islands 30 are formed of a nonferromagnetic material, such as a dielectric, or a material that has no substantial remanent moment in the absence of an applied magnetic field, or a magnetic material in a trench recessed far enough below the islands 30 to not adversely affect reading or writing. The nonmagnetic spaces may also be the absence of magnetic material, such as trenches or recesses in the magnetic recording layer or disk substrate.

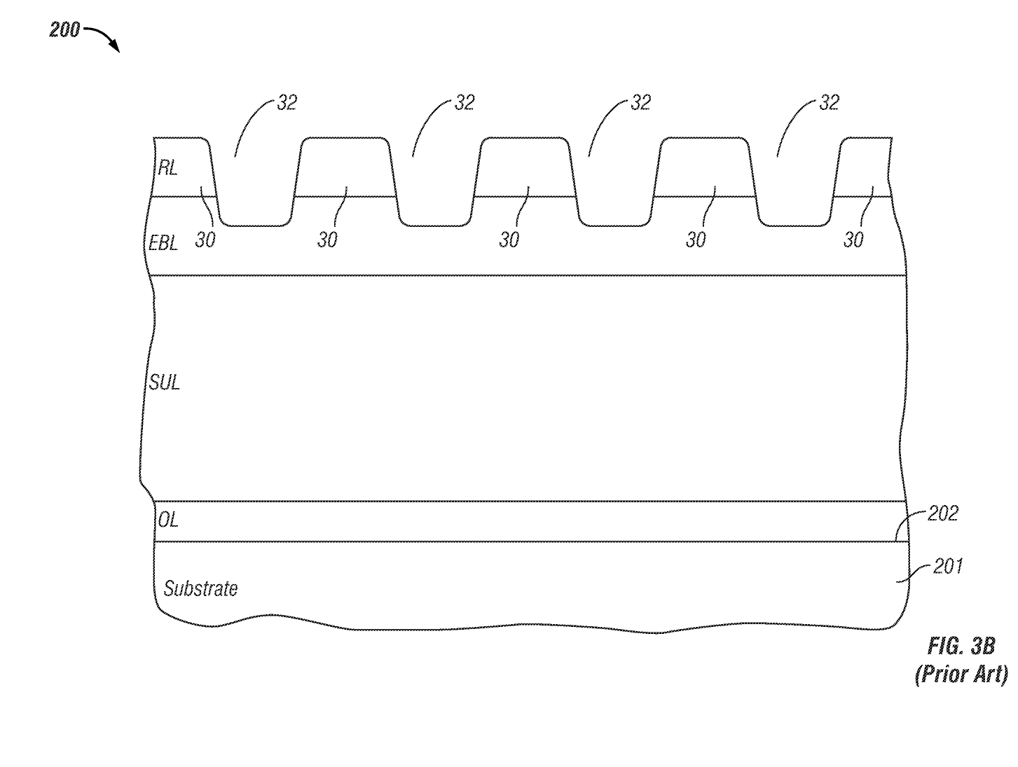

FIG. 3A is a sectional view showing the disk 200 according to the prior art before lithographic patterning and etching to form the BPM disk. The disk 200 is a substrate 201 having a generally planar surface 202 on which the representative layers are deposited, typically by sputtering. The disk 200 is depicted as a perpendicular magnetic recording disk with a recording layer (RL) having perpendicular (i.e., generally perpendicular to substrate surface 201) magnetic anisotropy and an optional soft magnetic underlayer (SUL) below the RL. The optional SUL serves as a flux return path for the magnetic write field from the disk drive write head.

The hard disk substrate 201 may be any commercially available glass substrate, but may also be a conventional aluminum alloy with a NiP surface coating, or an alternative substrate, such as silicon, canasite or silicon-carbide. An adhesion layer or onset layer (OL) for the growth of the SUL may be an AlTi alloy or a similar material with a thickness of about 2-10 nm is deposited on substrate surface 202.

The SUL may be formed of magnetically permeable materials such as alloys of CoNiFe, FeCoB, CoCuFe, NiFe, FeAlSi, FeTaN, FeN, FeTaC, CoTaZr, CoFeTaZr, CoFeB, and CoZrNb. The SUL may also be a laminated or multilayered SUL formed of multiple soft magnetic films separated by nonmagnetic films, such as electrically conductive films of Al or CoCr. The SUL may also be a laminated or multilayered SUL formed of multiple soft magnetic films separated by interlayer films that mediate an antiferromagnetic coupling, such as Ru, Ir, or Cr or alloys thereof. The SUL may have a thickness in the range of about 5 to 50 nm.

An exchange-break layer (EBL) is typically located on top of the SUL. It acts to break the magnetic exchange coupling between the magnetically permeable films of the SUL and the RL and also serves to facilitate epitaxial growth of the RL. The EBL may not be necessary, but if used it can be a nonmagnetic titanium (Ti) layer; a non-electrically-conducting material such as Si, Ge and SiGe alloys; a metal such as Cr, Ru, W, Zr, Nb, Mo, V, Ta and Al; a metal alloy such as NiW, NiTa, CrTi and NiP; an amorphous carbon such as CNₓ, CHₓ and C; or oxides, nitrides or carbides of an element selected from the group consisting of Si, Al, Zr, Ti, and B. The EBL may have a thickness in the range of about 1 to 40 nm.

The disk of FIG. 3A is lithographically patterned, for example by a nanoimprinting process. In nanoimprinting, a master template is fabricated, for example by direct e-beam writing, to have the desired pattern of data islands and nonmagnetic regions. A thin film of imprint resist (i.e., a thermoplastic polymer) is spin coated onto the disk. Then the master template with its predefined pattern is brought into contact with the imprint resist film and the template and disk are pressed together and heat is applied. When the imprint resist polymer is heated above its glass transition temperature, the pattern on the template is pressed into the resist film. After cooling, the master template is separated from the disk and the patterned resist is left on the RL. The patterned imprint resist is then used as an etch mask. Reactive-ion-etching (RIE) or ion milling can be used to transfer the pattern in the imprint resist to the underlying disk to form the data islands and nonmagnetic regions.

FIG. 3B is a sectional view of the disk 200 after lithographic patterning and etching. After etching, elevated lands 30 of RL material and grooves or recesses 32 are formed above the substrate surface 202. The typical depth of the recesses 32, which is also essentially the height of the lands 30, is in the range of about 4 to 50 nm and the typical width of the recesses is in the range of about 4 to 50 nm. In the example shown in FIG. 3B, the etching has been performed to a depth such that all of the RL material and a portion of the EBL material has been removed from the regions of the recesses 32. However, alternatively the etching can be performed to a depth such that only a portion of the RL material is removed. In that case, there would be a layer of RL material below the lower surface of the recesses 32.

FIG. 3C is a sectional view of the etched disk 200 of FIG. 3B after deposition of a protective overcoat 34 into the recesses 32 and over the tops of lands 30 and after deposition and chemical-mechanical-polishing (CMP) of fill material 36 in the recesses 32. The protective overcoat 34 is preferably a layer of amorphous carbon, like diamond-like carbon (DLC). The amorphous carbon or DLC may also be hydrogenated and/or nitrogenated, as is well-known in the art. Alternatively, the protective overcoat 34 may be a silicon nitride, such as Si₃N₄ or SiN_{X}. The fill material 36 may be SiO₂ or a polymeric material. The CMP results in essentially a planarized disk surface. An optional additional layer of protective overcoat (not shown) may then be deposited on the planarized surface, followed by a layer of conventional liquid lubricant (not shown).

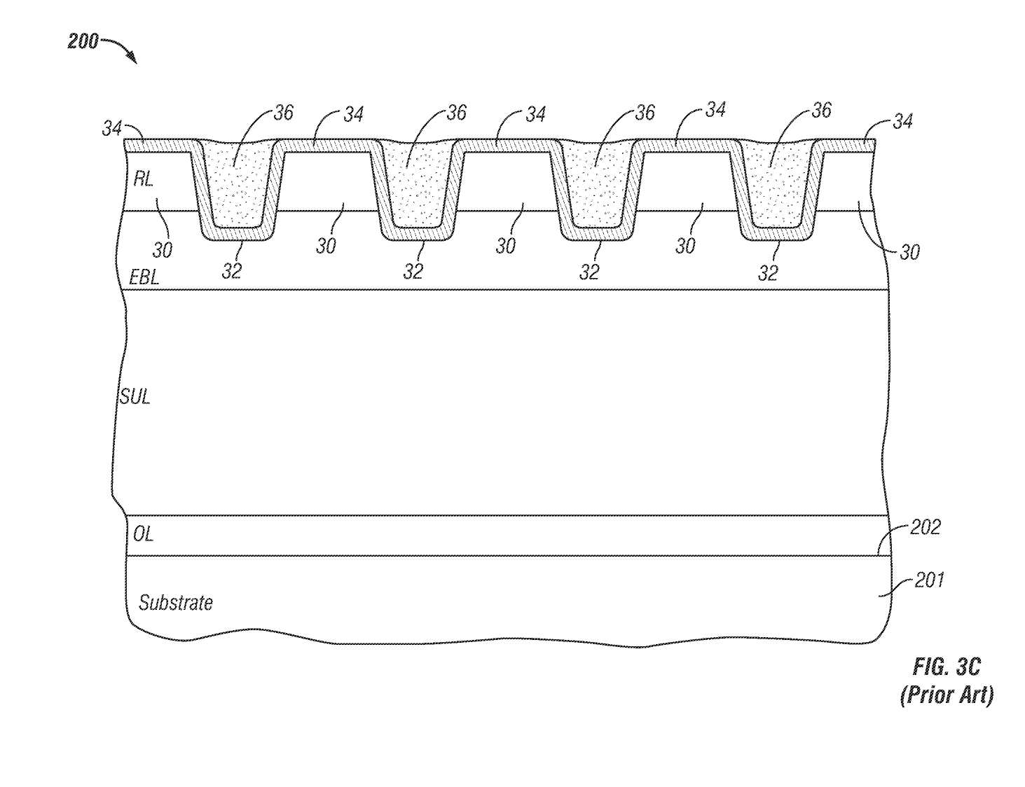

In the patterned perpendicular media of this invention the RL in the discrete magnetic islands is an exchange-coupled composite (ECC) structure with a high-Hₖ chemically-ordered FePt alloy lower layer, a lower-Hₖ Co/X laminate or multilayer (ML) upper layer with perpendicular magnetic anisotropy, wherein X is Pt, Pd or Ni, and an optional nonmagnetic separation layer or coupling layer (CL) between the FePt layer and the ML. FIG. 4 is a sectional view of a portion of a disk substrate showing a portion of the SUL with the EBL on it and a data island 230 according to the invention on the EBL. A seed layer structure 240 is deposited on the EBL to facilitate the growth of the FePt layer 250. The seed layer structure 240 may be a bilayer of a lower CrRu layer and an upper Pt layer on the CrRu layer. The total thickness of the EBL and seed layer structure 240 is preferably in the range of 1 nm to 25 nm. The FePt layer 250 is deposited on the seed layer structure 240 to a thickness in the range of about 3 to 10 nm. The nonmagnetic CL 260 is preferably a layer of Pt or Pd deposited on the FePt layer 250 to a thickness in the range of about 0.5 to 4 nm. The ML 270 is formed on the CL 260 and comprises a series of Co/X bilayers, wherein X is Pt, Pd or Ni. In FIG. 4, three bilayers are depicted, i.e., Co layers 271, 273, 275 and X layers 272, 274, 276. The number of bilayers and the relative thicknesses of the Co and X layers are selected to achieve the desired magnetic properties, including the value of the anisotropy field Hₖ. If the optional CL 260 is not used, then the X layer (Pt, Pd or Ni) of the first bilayer is deposited on the FePt layer 250, followed by alternating layers of Co and X, to complete the ML 270. An optional capping layer 280, such as a layer of Pd or Pt, may be deposited on the upper layer of the ML 270 to a thickness in the range of about 1 to 3 nm.

The hard (high-Hₖ) layer 250 in the ECC structure is preferably the chemically-ordered equiatomic binary alloy FePt based on the L1₀ phase. Chemically-ordered alloys of FePt (and FePd) ordered in L1₀ are known for their high magneto-crystalline anisotropy and magnetization, properties that are desirable for high-density magnetic recording materials. The chemically-ordered FePt alloy, in its bulk form, is known as a face-centered tetragonal (FCT) L1₀-ordered phase material (also called a CuAu material). The c-axis of the L1₀ phase is the easy axis of magnetization and is oriented perpendicular to the disk substrate. The chemically-ordered FePt alloy layer 250 may also be a pseudo-binary alloy based on the FePt L1₀ phase, e.g., (Fe(y)Pt(100−y))-X, where y is between about 45 and 55 atomic percent and the element X may be Ni, Au, Cu, Pd or Ag and is present in the range of between about 0% to about 20% atomic percent. While the pseudo-binary alloy in general has similarly high anisotropy as the binary alloy FePt, it allows additional control over the magnetic and structural properties of the RL.

The chemically-ordered FePt alloy layer 250 is sputter deposited onto the seed layer structure 240 while the disk substrate is maintained at an elevated temperature, above 300° C. and preferably above 500° C. The high-temperature deposition assures the high anisotropy field Hₖ can be achieved. The anisotropy field is preferably between about 30 and 150 kOe. The temperature of the disk substrate can be gradually decreased during the deposition, for example from a starting temperature of about 600° C. to a final temperature of about 300° C., to provide an FePt layer 250 with a graded anisotropy field, with the anisotropy field decreasing with increased thickness. The high-temperature deposition together with the CrRu/Pt seed layer structure 240, provide a very smooth surface for subsequent deposition of the CL 260 and ML 270. The upper surface of the FePt layer 250 should have a root-mean-square (RMS) surface roughness of less than 1 nm. As an alternative method for forming the high-Hₖ FePt layer 250, sequential alternating layers of Fe and Pt can be deposited by sputter depositing from separate Fe and Pt targets, using a shutter to alternately cover the Fe and Pt targets, followed by annealing the resulting structure at about 300° C. to 700° C. for about 1-30 min. Rapid thermal annealing (RTA), wherein the annealing time is very short (about 2 to 60 seconds) and the temperature is ramped up very quickly, may also be used.

The Co/X ML 270 preferably has between 2 and 10 Co/X bᵢlayers. The Hk in the Co/X ML is highest for thin Co layers in a thickness range of 0.1-0.4 nm. Also, Co/Ni bilayers will generally provide a lower Hₖ than Co/Pd and Co/Pt bilayers. In one example, a Co/Pd multilayer of 5 Co(0.28 nm)/Pd(0.9 nm) bilayers will have a Hₖ of about kOe and a Co/Ni multilayer of 3 Co(0.2 nm)/Ni(0.6 nm) bilayers will have a Hₖ of about 5 kOe. The Co/X ML is deposited by sequentially sputter depositing the Co and X layers at room temperature or temperatures below 200° C. for the desired time to produce the desired thicknesses. The anisotropy field of the ML is preferably between about 1 and 40 kOe.

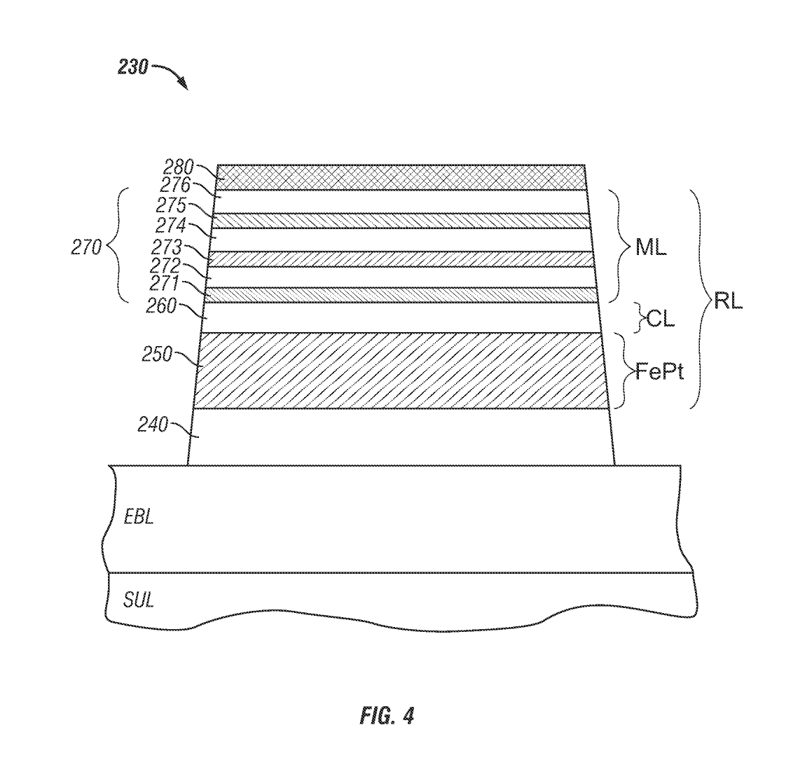

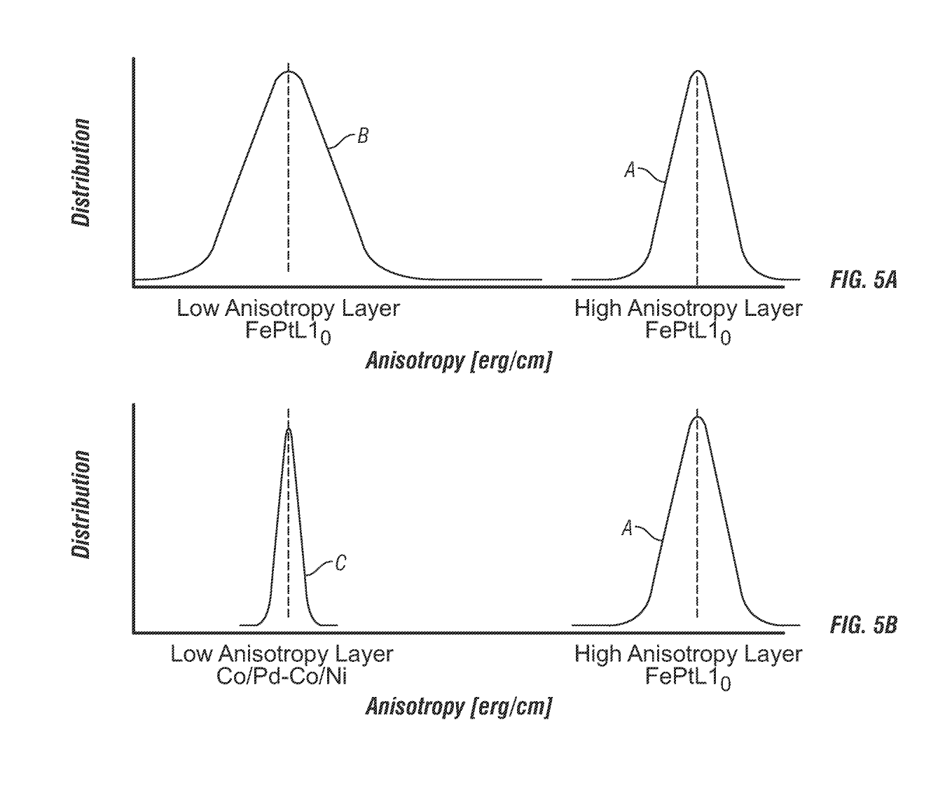

The ECC RL of this invention provides a narrow SFD. Chemically-ordered FePt, when deposited at lower temperatures (less than about 400° C.) to achieve a lower Hₖ, does not have a narrow SFD. The anisotropy field distribution becomes very broad with many grains being in-plane, while other grains are still partially L1₀ ordered. Therefore ECC structures based solely on FePt, such as a graded Hₖ FePt layer or separate FePt layers with different values of Hₖ, both of which require a part of the FePt ECC structure to be deposited at a lower temperature, are not desirable. FIG. 5A shows the comparison of anisotropy field distribution for a high-Hₖ FePt L1₀ layer deposited at about 500-700° C. to achieve a Hₖ of about 80 kOe (Curve A) with a lower-Hₖ FePt L1₀ layer deposited at about 200-400° C. to achieve a Hₖ of about 20 kOe (Curve B). FIG. 5A shows that the broad SFD exhibited in Curve B will likely result in an undesirable ECC structure based solely on FePt.

In the RL of this invention the separate Co/X ML, which can be deposited at room temperature, is used as the soft layer and has a very narrow SFD by itself. FIG. 5B shows the comparison of anisotropy field distribution for a high-Hk FePt L10 layer deposited at about 500-700° C. to achieve a Hk of about 80 kOe (Curve A) with a lower-Hk Co/Pd or Co/Ni ML deposited at room temperature to achieve a Hk of about 20 kOe (Curve C). FIG. 5B clearly shows the substantially narrower SFD (Curve C) over that of Curve B in FIG. 5A. Thus, the ECC RL according to this invention provides a narrow SFD of the composite system made of the hard (high-Hk) FePt layer (with SFD represented by Curve A) and the soft (lower-Hk) Co/X ML (with SFD represented by Curve C). That is, in general, the SFD for the FePt layer alone is greater than the SFD for the composite ECC RL, which is greater than the SFD for the ML alone. Also, the ECC RL provides a strong readback signal due to the well-defined perpendicular anisotropy of both the hard (high-Hk) FePt layer and the soft (lower-Hk) Co/X ML.

Perpendicular magnetic recording disks with BPM have been proposed primarily for use in conventional magnetic recording, wherein an inductive write head alone writes data to the islands. However, perpendicular BPM disks have also been proposed for use in heat-assisted recording, also called thermally-assisted recording (TAR). In a TAR system, an optical waveguide with a near-field transducer (NFT) directs heat from a radiation source, such as a laser, to heat localized regions of the magnetic recording layer on the disk. The radiation heats the magnetic material locally to near or above its Curie temperature to lower the coercivity enough for writing to occur by the inductive write head. The ECC RL of this invention is also applicable to perpendicular BPM disks for TAR disk drives.

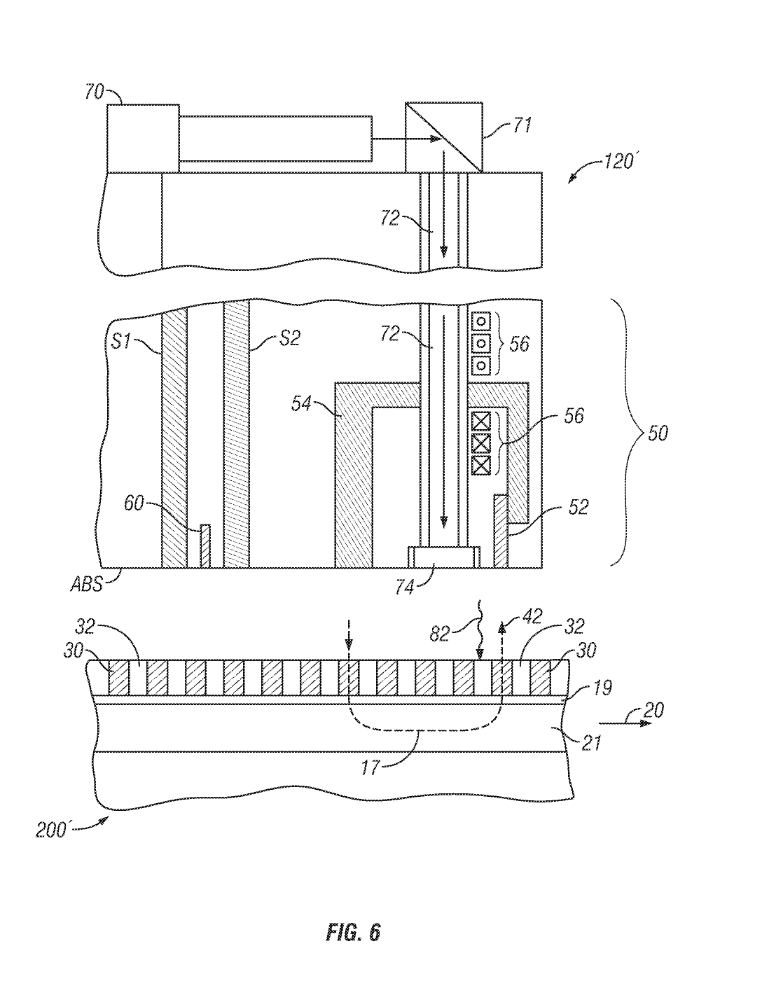

FIG. 1 thus depicts a conventional magnetic recording system with a perpendicular BPM disk 200 and an air-bearing slider 120 that supports the write head and read head. FIG. 6 depicts a sectional view, not drawn to scale because of the difficulty in showing the very small features, of an air-bearing slider 120′ for use in a TAR system and a portion of a TAR disk 200′. The air-bearing slider 120′ supports the write head 50 (with yoke 54 and write pole 52), read head 60, and shields S1 and S2. In the TAR disk 200′, a heat sink layer 21 is located below the islands 30 and nonmagnetic regions 32. The islands 30 may be islands having the ECC RL according to this invention, like island 230 in FIG. 4. Heat sink layer 21 is formed of a material that is a good thermal conductor, like Cu, Au, Ag or other suitable metals or metal alloys. Layer 19 may be a thermal resist layer, such as a layer of MgO or Si02, between the heat sink layer 21 and the islands 30 to help control the heat flow so that heat is not distributed too rapidly into the heat sink layer 21. The TAR disk 200′ may also include an optional SUL, which if present would be located below the heat sink layer 21. If there is no SUL, then there is no need for an EBL. The slider 120′ has an air-bearing surface (ABS) that faces the disk 200′. The slider 120′ also supports a laser 70, mirror 71, optical waveguide or channel 72 and NFT 74, which has its output at the ABS.

When write-current is directed through coil 56, the write pole 52 directs magnetic flux to the data islands 30, as represented by arrow 80 directed to one of the data islands 30. The dashed line 17 with arrows shows the flux return path back to the return pole 54. The NFT 74 directs near-field radiation, as represented by wavy arrow 82, to the data islands 31 as the TAR disk 10′ moves in the direction 23 relative to the slider. The electric charge oscillations in the NFT heat the data islands 30 at the same time the data islands are exposed to the write field from the write pole 52. This raises the temperature of the magnetic recording material in the data islands to near or above its Curie temperature to thereby lower the coercivity of the material and enable the magnetization of the data island to be switched by the write field. When the ECC RL according to this invention is used in the data islands in a TAR disk drive, the anisotropy field of the FePt layer is preferably between about 30 and 150 kOe and the anisotropy field of the ML is preferably between about 1 and 40 kOe and less than the anisotropy field of the FePt layer. Also, it may be desirable to alloy the Co with Ni in the ML in the data islands, e.g., CoNi/X (X═Pt or Pt) bilayers. This will allow tuning the Curie temperature of the soft ML to optimize performance in a TAR disk drive.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

1. A patterned perpendicular magnetic recording medium comprising:
a substrate; and
a plurality of discrete magnetic islands on the substrate and separated by substantially nonmagnetic regions, each island having a ferromagnetically exchange-coupled composite magnetic recording structure comprising a layer of chemically-ordered FePt alloy having perpendicular magnetic anisotropy on the substrate, and a multilayer on and ferromagnetically exchange coupled to the FePt layer, the multilayer being selected from the group consisting of a multilayer comprising Co/Pt, a multilayer comprising Co/Pd and a multilayer comprising Co/Ni.

2. The medium of claim 1 further comprising a nonmagnetic separation layer between the FePt layer and the multilayer.

3. The medium of claim 2 wherein the nonmagnetic separation layer is formed of a material selected from Pt and Pd.

4. The medium of claim 1 further comprising a seed layer structure between the substrate and the FePt layer.

5. The medium of claim 4 wherein the seed layer structure comprises a layer of a CrRu alloy and a layer of Pt on and in contact with the CrRu alloy layer.

6. The medium of claim 1 wherein the chemically-ordered FePt alloy is a chemically-ordered alloy of FePt—X, where the element X is selected from the group consisting of Ni, Au, Cu, Pd and Ag.

7. The medium of claim 1 further comprising a nonmagnetic capping layer on the multilayer.

8. The medium of claim 1 further comprising an underlayer of magnetically permeable material on the substrate and an exchange break layer between the underlayer and the FePt layer.

9. The medium of claim 1 further comprising a heat sink layer between the substrate and the FePt layer.

10. The medium of claim 1 wherein the anisotropy field of the FePt layer is between about 30 and 150 kOe and the anisotropy field of the multilayer is between about 1 and 40 kOe and less than the anisotropy field of the FePt layer.

11. A magnetic recording disk drive comprising:
the medium of claim 1;
a write head for magnetizing the magnetic recording material in the data islands; and
a read head for reading the magnetized data islands.

12. A thermally-assisted recording (TAR) magnetic recording disk drive comprising:
the medium of claim 1 further comprising a heat sink layer between the substrate and the FePt layer;
a write head for applying a magnetic field to the data islands;
an optical data channel and near-field transducer for directing radiation to the data islands to heat the islands; and
a read head for reading the magnetized data islands.

13. The TAR disk drive of claim 12 wherein the multilayer comprises a multilayer selected from a CoNi/Pd multilayer and CoNi/Pt multilayer.

14. A patterned perpendicular magnetic recording disk comprising:
a rigid disk substrate;
an underlayer of magnetically permeable material on the substrate;
an exchange break layer (EBL) on the underlayer;
a seed layer structure on the EBL; and
a plurality of discrete magnetic islands arranged in generally concentric data tracks on the seed layer structure and separated by substantially nonmagnetic regions, each island having a ferromagnetically exchange-coupled composite magnetic recording structure comprising a layer of chemically-ordered FePt alloy having perpendicular magnetic anisotropy on the seed layer structure, and a multilayer on and ferromagnetically exchange coupled to the FePt layer, the multilayer being selected from the group consisting of a multilayer comprising Co/Pt, a multilayer comprising Co/Pd and a multilayer comprising Co/Ni.

15. The disk of claim 14 further comprising a nonmagnetic separation layer between the FePt layer and the multilayer, the nonmagnetic separation layer being formed of a material selected from Pt and Pd.

16. The disk of claim 14 wherein the seed layer structure comprises a layer of a CrRu alloy and a layer of Pt on and in contact with the CrRu alloy layer.

17. The disk of claim 14 wherein the chemically-ordered FePt alloy is generally equiatomic FePt.

18. The disk of claim 14 wherein the chemically-ordered FePt alloy is a pseudo-binary alloy having the formula (Fe(y)Pt(100−y))-X, where y is between about 45 and 55 atomic percent and the element X may be Ni, Au, Cu, Pd or Ag and is present in the range of between about 0% to about 20% atomic percent.

19. The disk of claim 14 further comprising a nonmagnetic capping layer on the multilayer.

20. The disk of claim 14 wherein the anisotropy field of the FePt layer is between about 30 and 150 kOe and the anisotropy field of the multilayer is between about 1 and 40 kOe and less than the anisotropy field of the FePt layer.
